(19) United States
(12) Patent Application Publication
(10) Pub. No.: US 2024/0210179 A1
(43) Pub. Date: Jun. 27, 2024

(54) NAVIGATION DEVICE AND NAVIGATION METHOD

(71) Applicant: TOYOTA JIDOSHA KABUSHIKI KAISHA, Toyota-shi (JP)

(72) Inventors: Fumiyuki KAGARA, Sagamihara-shi (JP); Hiroyuki Nishizawa, Nagakute-shi (JP); Hirofumi Aino, Kawaguchi-shi (JP)

(73) Assignee: TOYOTA JIDOSHA KABUSHIKI KAISHA, Toyota-shi (JP)

(21) Appl. No.: 18/492,122

(22) Filed: Oct. 23, 2023

(30) Foreign Application Priority Data
Dec. 21, 2022 (JP) 2022-204710

(51) Int. Cl. G01C 21/34

(52) U.S. Cl. CPC G01C 21/3415; G01C 21/3476

(57) ABSTRACT

When the navigation device that guides the route to the destination to the user determines that the user cannot arrive at a specific location that is one of the destination and another point on the route by the scheduled time, the navigation device includes a control unit that searches a database in which a plurality of points selected by the user are registered in advance together with genre information for identifying genres of the respective points, determines an alternative location of the same genre as the specific location from among the plurality of points, and presents proposal data for proposing the determined alternative location to the user.

### CROSS-REFERENCE TO RELATED APPLICATION

This application claims priority to Japanese Patent Application No. 2022-204710 filed on Dec. 21, 2022, incorporated herein by reference in its entirety.

### BACKGROUND

### 1. Technical Field

The present disclosure relates to a navigation device and a navigation method.

### 2. Description of Related Art

Japanese Unexamined Patent Application Publication No. 2005-315660 (JP 2005-315660 A) discloses a navigation device that determines whether it is possible for a user to arrive at an input destination within the business hours of the destination and that, upon determining that it is not possible to arrive at the destination, provides guidance to an alternative location that is different from the destination and that can be arrived at within the business hours of the alternative location.

### SUMMARY

While rerouting is performed or an expected arrival time is updated in consideration of the traffic situation in conventional route guidance, a mechanism for improving user experience under time constraints is not provided.

It is an object of the present disclosure to provide a mechanism for improving user experience with respect to route guidance under time constraints.

The navigation device according to the present disclosure is a navigation device that provides a user with guidance on a route to a destination. The navigation device includes a control unit that, upon determining that the user is not able to arrive at a specific location that is one of the destination and another location on the route by a scheduled time, searches a database in which a plurality of locations selected by the user is registered in advance together with genre information for identifying genres of the respective locations to determine an alternative location of the same genre as the specific location from among the locations, and presents suggestion data that suggests the determined alternative location to the user.

The navigation method according to the present disclosure is a navigation method of providing a user with guidance on a route to a destination. The navigation method includes: upon determining that the user is not able to arrive at a specific location that is one of the destination and another location on the route by a scheduled time, searching, by a navigation device, a database in which a plurality of locations selected by the user is registered in advance together with genre information for identifying genres of the respective locations to determine an alternative location of the same genre as the specific location from among the locations; and presenting, by the navigation device, suggestion data that suggests the determined alternative location to the user.

According to the present disclosure, it is possible to provide a mechanism for improving user experience with respect to route guidance under time constraints.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a configuration of a system according to an embodiment of the present disclosure;

FIG. 2 is a block diagram illustrating a configuration of a navigation device according to an embodiment of the present disclosure;

FIG. 3 is a table illustrating an example of information registered in a database according to an embodiment of the present disclosure; and

FIG. 4 is a flowchart illustrating an operation of a navigation device according to an embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

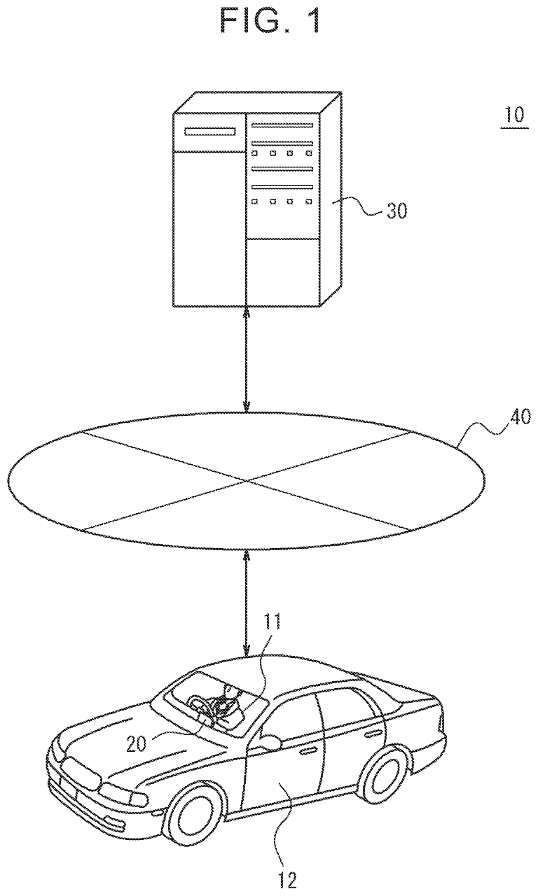

A configuration of the navigation system 10 according to the present embodiment will be described with reference to FIG. 1.

The navigation system 10 includes a navigation device 20 and a server device 30. The navigation device 20 can communicate with the server device 30 via the network 40.

The navigation device 20 is mounted on the vehicle 12 and is used by the user 11 riding on the vehicle 12. The navigation device 20 is an in-vehicle device having a function of guiding a route to a destination to the user 11, such as a car navigation device. Alternatively, the navigation device 20 may be connected to the vehicle 12 as an external device or may be held by the user 11. The navigation device 20 may be a mobile device having a function of guiding a route to a destination to the user 11, such as a mobile phone, a smartphone, or a tablet in which a map application is installed.

The server device 30 is installed in a facility such as a data center, and is operated by an operator who provides a service such as a web service. The server device 30 is a computer belonging to a cloud computing system or other computing system.

Vehicle 12 may be any type of vehicle, such as, for example, a gas-powered vehicle, a die-powered vehicle, a HEV, PHEV, BEV, or a FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The vehicle 12 is driven by the user 11 in the present embodiment, but the driving may be automated at an arbitrary level. The level of autonomous driving is, for example, one of levels 1 to 5 in the SAE leveling, for example. “SAE” is an abbreviation for Society of Automotive Engineers. The vehicle 12 may be a MaaS dedicated vehicle. “MaaS” is an abbreviation for Mobility as a Service.

The network 40 includes the Internet, at least one WAN, at least one MAN, or any combination thereof. “WAN” is an abbreviation for wide area network. “MAN” is an abbreviation for metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. “LAN” is an abbreviation for local area network.

A description will be made on an overview of this embodiment with reference to FIG. 1 to FIG. 3.

When the navigation device 20 determines that the user 11 cannot arrive at the specific location Px which is one of the destination and another point on the route by the scheduled time Tx, the plurality of points 51 selected by the user 11 searches the database 27 registered in advance together with the genre information 54 for identifying the genre of the respective points, thereby determining the alternative location Py of the same genre as the specific location Px from among the plurality of points 51. The navigation device 20 presents the user 11 with suggestions suggesting the determined alternative location Py.

In the present embodiment, since the alternative is presented from the favorite point selected by the user 11, the user 11 can enjoy the travel in time without significantly lowering the satisfaction level. For example, the user 11 was unable to go to a store where he or she originally wanted to go because of the lack of time. However, it can be seen that, in fact, a popular shop of the same genre is close to the shop that the user 11 wanted to go, and the experience that the user could go to the shop instead is enabled. In particular, such an experience is easy to obtain when the user 11 registers a store without knowing the location of the store. It is difficult to investigate alternatives during operation. However, in the present embodiment, the user 11 can smoothly change the schedule by selecting an alternative from the proposal of the system. In the related art, the alternative location does not necessarily reflect the preference, and there is a high possibility that the user satisfaction level is lowered. In the present embodiment, since the alternative is presented from the point registered by the user 11, the user satisfaction is less likely to decrease. That is, according to the present embodiment, it is possible to provide a mechanism for improving a user experience with respect to route guidance while there is a time restriction.

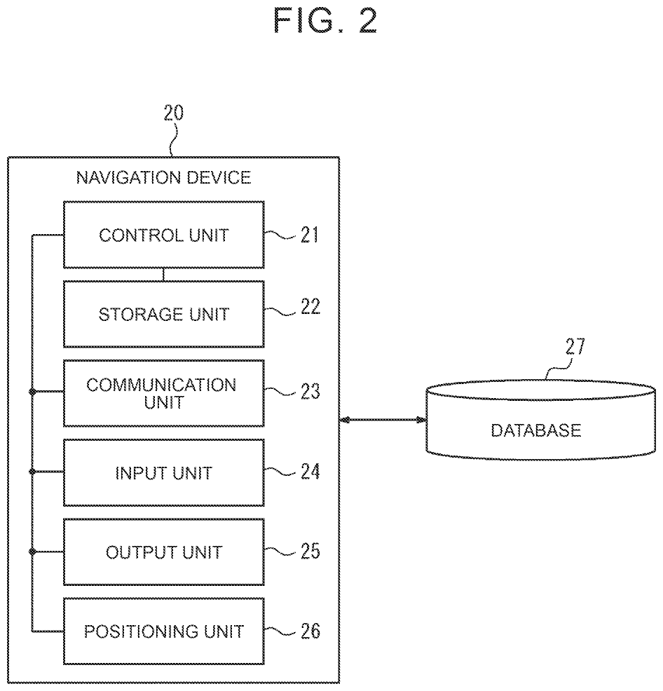

A configuration of the navigation device 20 according to the present embodiment will be described with reference to FIG. 2.

The navigation device 20 includes a control unit 21, a storage unit 22, a communication unit 23, an input unit 24, an output unit 25, and a positioning unit 26.

The control unit 21 includes at least one processor, at least one programmable circuit, at least one dedicated circuit, or any combination thereof. The processor is a general-purpose processor such as a CPU or a GPU, or a dedicated processor specialized for a specific process. “CPU” is an abbreviation for central processing unit. “GPU” is an abbreviation for graphics processing unit. The programmable circuit is, for example, an FPGA. “FPGA” is an abbreviation for field-programmable gate array. The dedicated circuit is, for example, an ASIC. “ASIC” is an abbreviation for application specific integrated circuit. The control unit 21 executes processing related to the operation of the navigation device 20 while controlling each unit of the navigation device 20.

The storage unit 22 includes at least one semiconductor memory, at least one magnetic memory, at least one optical memory, or any combination thereof. The semiconductor memory is, for example, a RAM, a ROM, or a flash memory. “RAM” is an abbreviation for random access memory. “ROM” is an abbreviation for read only memory. The RAM is, for example, an SRAM or a DRAM. “SRAM” is an abbreviation for static random access memory. “DRAM” is an abbreviation for dynamic random access memory. The ROM is, for example, an EEPROM. “EEPROM” is an abbreviation for electrically erasable programmable read only memory. The flash memory is, for example, an SSD. “SSD” is an abbreviation for solid-state drive. The magnetic memory is, for example, an HDD. “HDD” is an abbreviation for hard disk drive. The storage unit 22 functions as, for example, a main storage device, an auxiliary storage device, or a cache memory. The storage unit 22 stores data used for the operation of the navigation device 20 and data obtained by the operation of the navigation device 20. In the present embodiment, the database 27 is constructed in the storage unit 22, but the database 27 may be constructed in an external storage to which the communication unit 23 can be connected.

The communication unit 23 includes at least one communication interface. The communication interface is, for example, an interface corresponding to a mobile communication standard such as LTE, 4G standard or 5G standard, or a wireless LAN communication standard such as IEEE802.11. “LTE” is an abbreviation for Long Term Evolution. The term “4G” is an abbreviation for fourth generation. “5G” is an abbreviation for fifth generation. “IEEE” is an abbreviation for Institute of Electrical and Electronics Engineers. The communication unit 23 communicates with the server device 30. The communication unit 23 receives data used for the operation of the navigation device 20 and transmits data obtained by the operation of the navigation device 20.

The input unit 24 includes at least one input interface. The input interfaces are, for example, physical keys, capacitive keys, pointing devices, touch screens integrally provided with the display, visible-light cameras, depth cameras, LiDAR, or microphones. “LiDAR” is an abbreviation for light detection and ranging. The input unit 24 receives an operation of inputting data used for the operation of the navigation device 20. Instead of being provided in the navigation device 20, the input unit 24 may be connected to the navigation device 20 as an external input device. As the connecting interface, an interface corresponding to a standard such as USB, HDMI (registered trademark) or Bluetooth (registered trademark) can be used. “USB” is an abbreviation for Universal Serial Bus. “HDMI” is a High-Definition Multimedia Interface abbreviation.

The output unit 25 includes at least one output interface. The output interface is, for example, a display or a speaker. The display is, for example, an LCD or an organic EL display. “LCD” is an abbreviation for liquid crystal display. “EL” is an abbreviation for electro luminescent. The output unit 25 outputs data obtained by the operation of the navigation device 20. The output unit 25 may be connected to the navigation device 20 as an external output device, such as display audio, instead of being provided in the navigation device 20. As the connecting interface, an interface corresponding to a standard such as USB, HDMI (registered trademark) or Bluetooth (registered trademark) can be used.

The positioning unit 26 includes at least one GNSS receiver. GNSS is an abbreviation for global navigation satellite system. The GNSS is, for example, GPS, QZSS, BDS, GLONASS, or Galileo. “GPS” is an abbreviation for Global Positioning System. “QZSS” is an abbreviation for Quasi-Zenith Satellite System. The satellites of the QZSS are referred to as quasi-zenith satellites. “BDS” is an abbreviation for Bei Dou Navigation Satellite System. “GLONASS” is an abbreviation for Global Navigation Satellite System. The positioning unit 26 measures the position of the navigation device 20.

The function of the navigation device 20 is realized by executing the program according to the present embodiment by a processor serving as the control unit 21. That is, the functions of the navigation device 20 are realized by software. The program causes the computer to function as the navigation device 20 by causing the computer to execute the operation of the navigation device 20. That is, the computer functions as the navigation device 20 by executing the operation of the navigation device 20 according to the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. “SD” is an abbreviation for Secure Digital. “DVD” is an abbreviation for digital versatile disc. “CD-ROM” is an abbreviation for compact disc read only memory. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. “ASP” is an abbreviation for application service provider. The program includes information that is used for processing by electronic computers and equivalent to a program. For example, data that is not a direct command to a computer but has the property of defining the processing of the computer corresponds to the “data equivalent to a program”.

Some or all of the functions of the navigation device 20 may be realized by a programmable circuit or a dedicated circuit as the control unit 21. That is, some or all of the functions of the navigation device 20 may be realized by hardware.

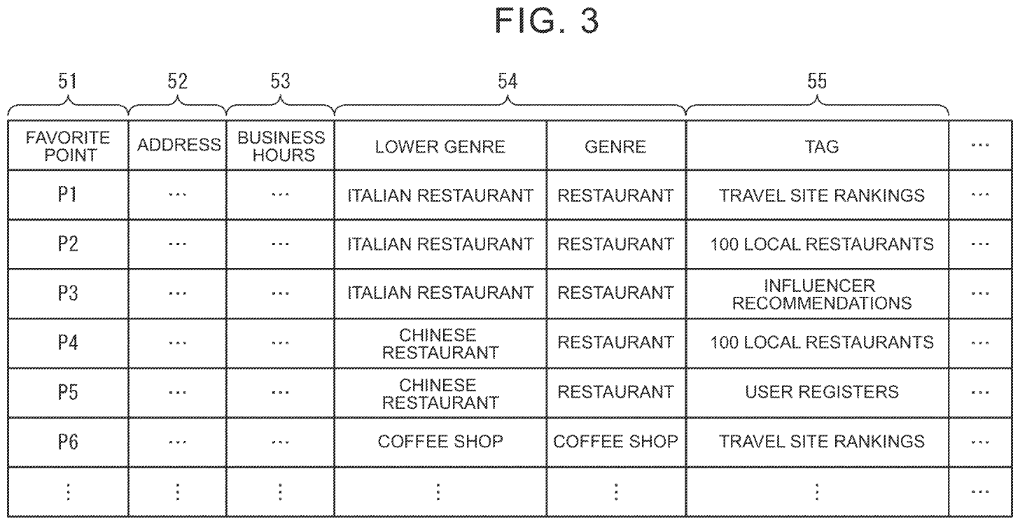

An example of information registered in the database 27 will be described with reference to FIG. 3.

In the exemplary embodiment illustrated in FIG. 3, as the plurality of points 51 selected by the user 11, at least six favorite locations P1, P2, P3, P4, P5, P6 are registered in advance in the database 27 together with the address 52 of each point, the business hours 53 of each point, and the genre information 54 for identifying the genre of each point. In the genre information 54, each point is categorized by a hierarchical genre. For example, the lower genre of the favorite locations P1, P2, P3 is “Italian restaurant.” The lower genre of the favorite locations P4, P5 is “Chinese restaurant”, which is different from the lower genre of the favorite locations P1, P2, P3. At one level above, the categories of favorite locations P1, P2, P3, P4, P5 are all “restaurants.” The lower genre of the favorite location P6 is “coffee shop.” Even in the level higher by one level, the category of favorite location P6 is a “coffee shop,” which is different from the category of favorite locations P1, P2, P3, P4, P5.

When registering a favorite point, the user 11 may register a point that the user actively searched for, or may collectively register a point included in the package by selecting a package in which a point recommended by a third party such as a travel specialist magazine, a travel site, a gourmet review site, or an influencer trusted by the user 11 is collected. In the example illustrated in FIG. 3, a tag 55 indicating whether each point has been individually registered by the user 11 or registered as a result of selecting a certain package is also registered in the database 27. For example, the favorite locations P1, P6 are registered as a result of the selection of a package of stores in the ranking of the travel site. The favorite locations P2, P4 are registered as a result of the selection of the regional restaurant 100. The Favorite Point P3 is registered as a consequence of the selection of a package called Influencer Recommendation. The favorite location P5 is individually registered by the user 11.

The information registered in the database 27 is not limited to the example illustrated in FIG. 3, and a part of the information may be omitted, simplified, or replaced with another information, or another information may be added. For example, address 52 and business hours 53 may be omitted and may be obtained from an external system only when needed. In the genre information 54, the genre may not be hierarchized. Alternatively, in the genre information 54, the genre may be hierarchized into three or more stages. The tag 55 may be omitted.

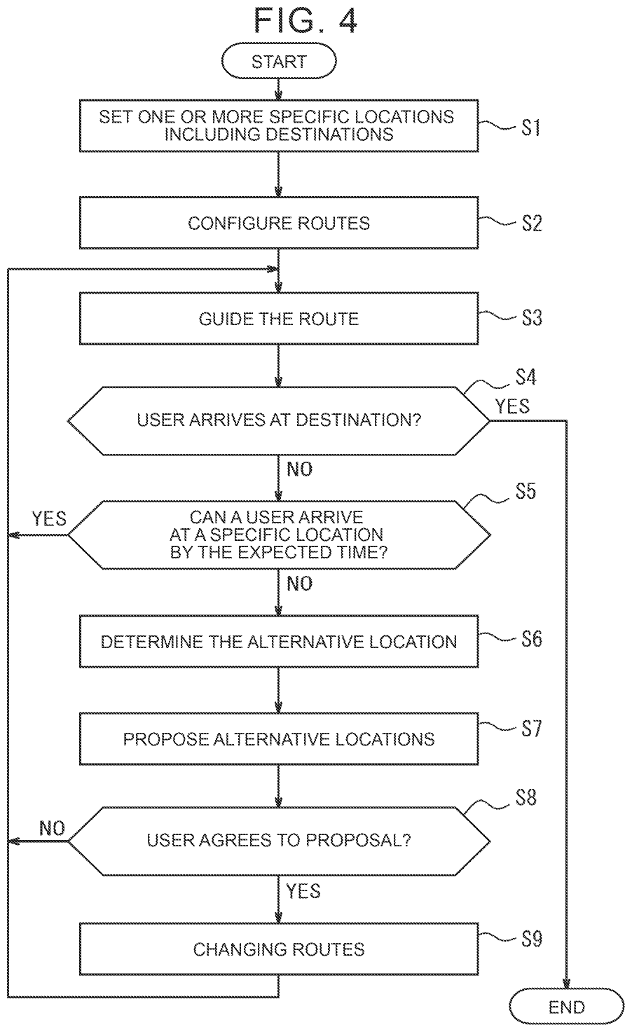

The operation of the navigation device 20 according to the present embodiment will be described with reference to FIG. 4. This operation corresponds to the navigation method according to the present embodiment.

In S1, the control unit 21 sets one or more specific locations including a destination. Specifically, the control unit 21 sets the destination by receiving an operation of designating the destination from the user 11 via the input unit 24. Alternatively, the control unit 21 may automatically set the destination by referring to calendar data indicating a schedule such as a travel plan of the user 11. The calendar data may be stored in advance in the storage unit 22 or may be stored in an external storage that can be connected to the communication unit 23. The control unit 21 may further set a specific location other than the destination by receiving an operation of designating a via point from the user 11 via the input unit 24. Alternatively, the control unit 21 may further automatically set a specific location other than the destination by referring to the calendar data.

In S2, the control unit 21 sets a route to the destination set by S1. When a specific location other than the destination is further set in S1, the control unit 21 sets a route to the destination that passes through the specific location. As a specific method of the route setting, a known method can be used. Machine learning such as deep learning may be used.

In S3, the control unit 21 guides the route set by S2 via the output unit 25. As a specific method of route guidance, a known method can be used.

In S4, the control unit 21 determines whether or not the user 11 has arrived at the destination. Specifically, the control unit 21 refers to the positioning result obtained from the positioning unit 26, and determines whether or not the user 11 has arrived at the destination by determining whether or not the current location of the vehicle 12 matches the destination. When it is determined that the user 11 has arrived at the destination, the flow illustrated in FIG. 4 ends. When it is determined that the user 11 has not arrived at the destination, S5 process is executed.

In S5, the control unit 21 determines whether the user 11 can arrive at the specific location Px by the scheduled time Tx. The specific location Px is a destination or another specific location set by S1 when a specific location other than the destination is further set by S1. That is, the specific location Px is one of the destination and another point on the route set by S2. The scheduled time Tx may be a time at which the specific location Px is closed, such as an end-of-business time of the specific location Px, but in the present embodiment, the time at which the user 11 stays at the specific location Px is subtracted from the time at which the specific location Px is closed. The time at which the user 11 stays at the specific location Px may be estimated from the mean time of stay of other users at the specific location Px, or may be entered by the user 11 as the scheduled time of stay. As a modification of the present embodiment, the scheduled time Tx may be designated by the user 11 or may be automatically set by referring to the calendar data when the specific location Px is set by S1.

Specifically, the control unit 21 refers to the positioning result obtained from the positioning unit 26 and the map data, and predicts the required time from the current position of the vehicle 12 to the specific location Px. The map data may be stored in advance in the storage unit 22 or may be stored in an external storage to which the communication unit 23 can be connected. The control unit 21 may further refer to various kinds of information such as road conditions or weather that can be acquired from the server device 30 via the communication unit 23 to predict the required time. The control unit 21 determines whether or not the user 11 can arrive at the specific location Px by the scheduled time Tx by determining whether or not the time obtained by adding the predicted required time to the present time is later than the scheduled time Tx. When it is determined that the user 11 can arrive at the specific location Px by the scheduled time Tx, S3 process is executed again. When it is determined that the user 11 cannot arrive at the specific location Px by the scheduled time Tx, S6 process is executed.

In S6, the control unit 21 searches the database 27 to determine the alternative location Py of the same genre as the specific location Px from among the plurality of points 51. In the embodiment illustrated in FIG. 3, assuming that the specific location Px is a coffee shop, the control unit 21 may determine the favorite location P6 as the alternative location Py after executing the same process as S5 on the favorite location P6. That is, when the control unit 21 determines that the user 11 can arrive at the favorite location P6 by the scheduled time Ty, it determines the favorite location P6 as the alternative location Py. The scheduled time Ty is a time obtained by subtracting the time at which the user 11 stays at the favorite location P6 from the time at which the favorite location P6 closes. The time at which the user 11 stays at the favorite location P6 may be estimated from the mean stay time of other users at the favorite location P6, or may be the same as the time at which the user 11 stays at the specific location Px.

In the present embodiment, when there are two or more points of the same genre as the specific location Px among the plurality of points 51, the control unit 21 determines the alternative location Py in accordance with the distance from the specific location Px, the evaluation by another user, or a combination thereof. In the embodiment illustrated in FIG. 3, assuming that the specific location Px is a Chinese restaurant, the control unit 21 may determine the alternative location Py from the favorite locations P4, P5 after performing the same process as S5 on the favorite locations P4, P5. That is, when the control unit 21 determines that the user 11 can arrive at any of the favorite locations P4, P5 by the scheduled time Ty, the control unit determines, as the alternative location Py, the favorite locations P4, P5 that is closer to the specific location Px, that is closer to the evaluation of the other user, or that is closer to the specific location Px and that is higher in the evaluation of the other user.

In the present embodiment, when the point of the same genre as the specific location Px is not in the plurality of points 51 in a certain hierarchy, the control unit 21 determines the point of the same genre as the specific location Px in one hierarchy as the alternative location Py. In the embodiment illustrated in FIG. 3, assuming that the specific location Px is a Chinese restaurant, the control unit 21 executes the same process as S5 for the favorite locations P4, P5. If the control unit 21 determines that the user 11 cannot arrive at any of the favorite locations P4, P5 by the scheduled time Ty, the control unit may perform the same process as S5 on the favorite locations P1, P2, P3 and determine the alternative location Py from the favorite locations P1, P2, P3. That is, when the control unit 21 determines that the user 11 can arrive at any of the favorite locations P1, P2, P3 by the scheduled time Ty, the control unit determines, as the alternative location Py, the favorite locations P1, P2, P3 that is closest to the specific location Px, that is closest to the evaluation of the other user, or that is closest to the specific location Px and that is highly evaluated by the other user.

In S7, the control unit 21 presents, to the user 11 via the output unit 25, proposal data for proposing the alternative location Py determined by S6. Specifically, the control unit 21 displays a message for proposing the alternative location Py on the display as the output unit 25. Alternatively, the control unit 21 may output a message for proposing the alternative location Py by sound from the speaker as the output unit 25.

In S8, the control unit 21 receives, from the user 11 via the input unit 24, an operation of inputting whether or not to agree with the proposal of the alternative location Py. If the user 11 does not agree to the suggestion, S3 process is re-executed. If the user 11 agrees to the suggestion, S9 process is executed.

In S9, when the specific location Px is the destination, the control unit 21 changes the route set by S2 to the route to the alternative location Py. When the specific location Px is other than the destination, the control unit 21 changes the route set by S2 to a route to the destination that passes through the alternative location Py. As a specific method of the route change, a known method can be used. Machine learning such as deep learning may be used. After S9, S3 process is executed again.

According to the present embodiment, by presenting the alternative plan in consideration of the stay time, it is easy to avoid a situation in which the user 11 arrives at the destination or the waypoint within the business time, but the arrival is delayed, and therefore the planned meal or event cannot be experienced.

When the destination is set by S1, the user 11 may be allowed to enter a desired arrival time. For example, the user 11 may be allowed to input a desire to arrive at a hotel as a destination by what time. In S5, the control unit 21 may determine whether or not the user 11 can go to a coffee shop that is a waypoint by back calculating from the time. If there is no time for the user 11 to visit the coffee shop, in S6, the control unit 21 May determine in an alternative location Py a store in which the user 11 may arrive at the hotel at another coffee shop at a desired time.

When the duration is predicted in S5, a near-future congestion prediction may be considered. By considering the congestion forecast in the near future, it is possible to accurately determine whether the user 11 can arrive at the specific location Px by the scheduled time Tx.

When the alternative location Py is determined in S6, information indicating that the user satisfaction is high or not low when the alternative is presented to the user who has selected the same destination or the via point in the past, or information indicating that the number of such users is high may be considered.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A navigation device that provides a user with guidance on a route to a destination, the navigation device comprising a control unit that, upon determining that the user is not able to arrive at a specific location that is one of the destination and another location on the route by a scheduled time, searches a database in which a plurality of locations selected by the user is registered in advance together with genre information for identifying genres of the respective locations to determine an alternative location of the same genre as the specific location from among the locations, and presents suggestion data that suggests the determined alternative location to the user.

2. The navigation device according to claim 1, wherein the control unit determines the alternative location in accordance with a distance from the specific location, evaluation by another user, or a combination of the distance and the evaluation when there are two or more locations of the same genre as the specific location among the locations.

3. The navigation device according to claim 1, wherein:
the locations are categorized into layers of genres in the genre information; and
when there is no location of the same genre as the specific location among the locations in a certain layer, the control unit determines, as the alternative location, a location of the same genre as the specific location in a layer that is one level higher than the certain layer.

4. The navigation device according to claim 1, wherein the scheduled time is obtained by subtracting a time for which the user stays at the specific location from a time when the specific location is closed.

5. A navigation method of providing a user with guidance on a route to a destination, the navigation method comprising:
upon determining that the user is not able to arrive at a specific location that is one of the destination and another location on the route by a scheduled time, searching, by a navigation device, a database in which a plurality of locations selected by the user is registered in advance together with genre information for identifying genres of the respective locations to determine an alternative location of the same genre as the specific location from among the locations; and
presenting, by the navigation device, suggestion data that suggests the determined alternative location to the user.
